(19) United States
(12) Patent Application Publication
(10) Pub. No.: US 2009/0185633 A1
(43) Pub. Date: Jul. 23, 2009

(54) Method and System for Specifying the Location of Data Bursts

(75) Inventors: Phillip Barber, McKinney, TX (US); Limei Wang, San Diego, CA (US)

Correspondence Address: Slater & Matsil, L.L.P., 17950 Preston Road, Suite 1000, Dallas, TX, 75252, US

(73) Assignee: FutureWei Technologies, Inc., Plano, TX (US)

(21) Appl. No.: 12/355,744

(22) Filed: Jan. 16, 2009

Related U.S. Application Data
(60) Provisional application No. 61/022,176, filed on Jan. 18, 2008.
(60) Provisional application No. 61/022,257, filed on Jan. 18, 2008.

(51) Int. Cl. H04L 27/28; H04B 7/00

(52) U.S. Cl. 375/260; 370/310

(57) ABSTRACT

A system and method for locating data subbursts in a data transmission is provided. A preferred embodiment comprises receiving data subbursts with different MCIDs at a mobile station. The mobile station also receives an indicator message which indicates the location of the data subbursts with MCIDs associated with the mobile station, and the mobile station selectively decodes the data subbursts with the MCIDs associated with the mobile station without decoding the remaining data subbursts.

This application claims the benefit of U.S. Provisional Application No. 61/022,176, filed on Jan. 18, 2008, entitled “Method and System for Specifying the Location of MBS Bursts Over a Wireless Network,” and also U.S. Provisional Application No. 61/022,257, filed on Jan. 18, 2008, entitled “Method and Apparatus for Transmitting a Packet Header in a Wireless Communication System,” which applications are both hereby incorporated herein by reference.

### TECHNICAL FIELD

The present invention relates generally to a system and method for transmitting information wirelessly, and more particularly to a system and method for specifying the location of information in a multicast and broadcast service burst.

### BACKGROUND

Generally, demand for multicast and broadcast service (MBS) has been on the rise in recent years as mobile units (e.g., cell phones) make the transition away from merely voice services and towards more multimedia and data services such as video broadcasts. MBS is enabled by the IEEE Broadband Wireless Access Systems 802.16e standard, which is detailed IEEE “Part 16: Air Interface for Broadband Wireless Access Systems,” and which is hereby incorporated by reference.

The MBS specification generally sets up zones that contain one or more base stations that operate using identical Multicast Channel Identifications (MCIDs) and Security Associations (SAs). A mobile station located within the zone can pick up information from one or more of the base stations located within the zone in order to receive MBS data bursts, which are usually a plurality of subbursts sent synchronously with each other. Along with the multiple subbursts, the base station will also send an MBS MAP which is used to notify each mobile station in the zone of the physical channel resources allocated to them.

However, in order to receive the appropriate data, the mobile stations must first decode the entire burst in order to locate the appropriate MCID. Then, once located, the remainder of the data burst is discarded, leaving only the data with the appropriate MCID. This requirement to decode the entire burst makes the mobile stations less efficient and slows down the processing of the appropriate data for at least the time it takes to decode and discard unwanted data.

### SUMMARY OF THE INVENTION

These and other problems are generally solved or circumvented, and technical advantages are generally achieved, by preferred embodiments of the present invention which provide a method and system for transmitting data over a wireless communication network.

In accordance with a preferred embodiment of the present invention, a method for receiving data comprises receiving a plurality of data subbursts at a mobile station with a first identifier, the plurality of data subbursts associated with different identifiers, one or more of the different identifiers being the first identifier. An indicator message indicating a location of a first one of the plurality of data subbursts with the first identifier is received at the mobile station, and the first one of the plurality of data subbursts with the first identifier is decoded without decoding a second one of the plurality of data subbursts.

In accordance with another preferred embodiment of the present invention, a method for transmitting data comprises transmitting a first data subburst with a first identifier and transmitting a second data subburst with a second identifier different from the first identifier. An indication of a location of the first data subburst and the second data subburst is transmitted, the indication of the location being associated with the first identifier and the second identifier.

In accordance with yet another preferred embodiment of the present invention, a method for receiving data comprises receiving an MBS_MAP2 at a mobile station, the MBS_MAP2 comprising an MBS_DATA2_IE. A first data subburst with a first channel identification and a second data subburst with a second channel identification different from the first channel identification are received. The MBS_DATA2_IE is processed to obtain a location of the first data subburst. The first data subburst is decoded without decoding the second data subburst.

An advantage of a preferred embodiment of the present invention is that a mobile station may selectively decode the data subbursts without having to decode the entire burst. Accordingly, decoding of the data subbursts can be performed faster, more efficiently, and with reduced power consumption.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a wireless communications network in accordance with an embodiment of the present invention;

FIG. 2 illustrates a base station and several mobile stations from a wireless communications network in accordance with an embodiment of the present invention;

FIG. 3 illustrates an example set of orthogonal frequency division multiple access (OFDMA) time-frequency radio resources in accordance with an embodiment of the present invention; and FIG. 4 illustrates a general downlink frame structure in accordance with an embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a multicast and broadcast service (MBS) transmission over a wireless link. The invention may also be applied, however, to other data transmissions.

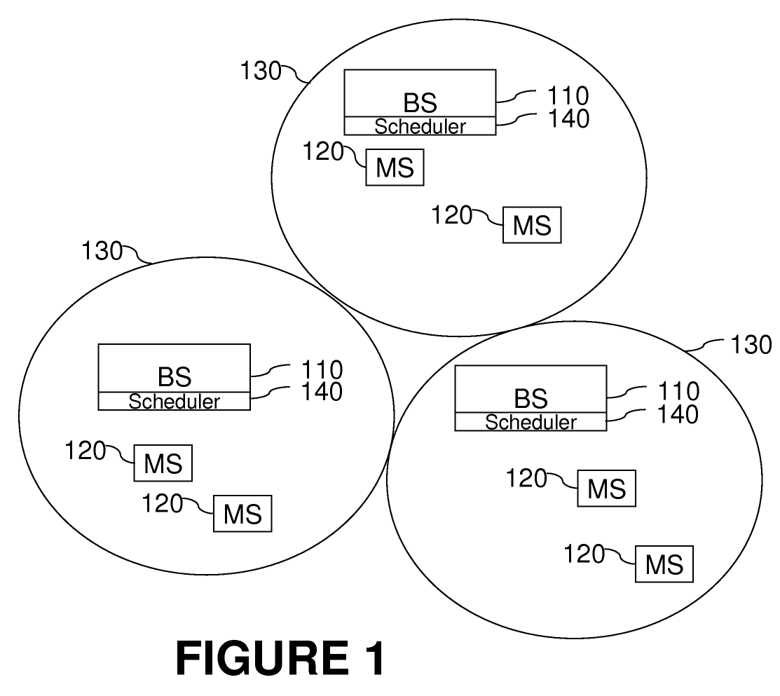

With reference now to FIG. 1, there is shown a wireless communications network which preferably comprises a plurality of base stations (BS) 110 providing voice and/or data wireless communication service to a plurality of mobile stations (MS s) 120. The BSs 110, which may also be referred to by other names such as access network (AN), access point (AP), Node-B, etc., preferably downlink (DL) information to the MSs 120 while also receiving uplink (UL) information from the MSs 120.

Each BS 110 preferably has a corresponding coverage area 130. These coverage areas 130 represent the range of each BS 110 to adequately transmit data, and, while not necessarily shown in FIG. 1, the coverage areas 130 of adjacent BSs 110 preferably have some overlap in order to accommodate handoffs between BSs 110 whenever a MS 120 exits one coverage area 130 and enters an adjacent coverage area 130. Each BS 110 also preferably includes a scheduler 140 for allocating radio resources to the MSs 120.

Preferably, the wireless communications network includes, but is not limited to, an orthogonal frequency division multiple access (OFDMA) network such as an Evolved Universal Terrestrial Radio Access (E-UTRA) network, an Ultra Mobile Broadband (UMB) network, or an IEEE 802.16 network. However, as one of ordinary skill in the art will recognize, the listed networks are merely illustrative and are not meant to be exclusive. Any suitable multiple access scheme network, such as a frequency division multiplex access (FDMA) network wherein time-frequency resources are divided into frequency intervals over a certain time interval, a time division multiplex access (TDMA) network wherein time-frequency resources are divided into time intervals over a certain frequency interval, a code division multiplex access (CDMA) network wherein resources are divided into orthogonal or pseudo-orthogonal codes over a certain time-frequency interval, or the like may alternatively be used.

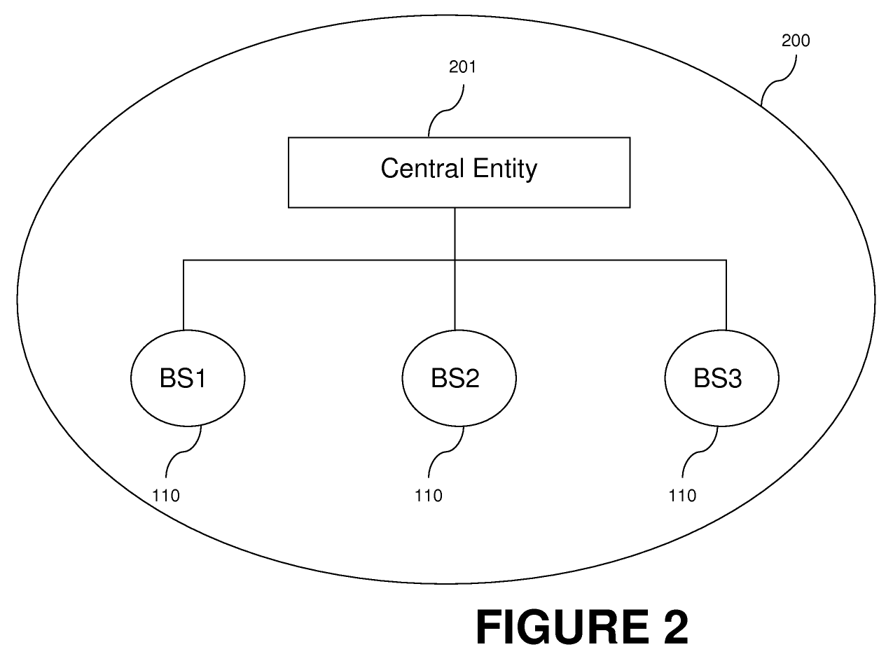

FIG. 2 illustrates a MBS zone 200 which may contain multiple BSs 110 such as BS1, BS2, and BS3. A centralized entity 201 will preferably assign a MCID for each given multicast broadcast content to be broadcast, and this assigned MCID is preferably broadcast from each BS 110 broadcasting the multicast broadcast content in the MBS zone 200. Each MS 120 (not shown in FIG. 2 but illustrated in FIG. 1) that is interested in the given multicast broadcast content will preferably receive the multicast broadcast content's MCID from a control channel broadcast by one or more BSs 110.

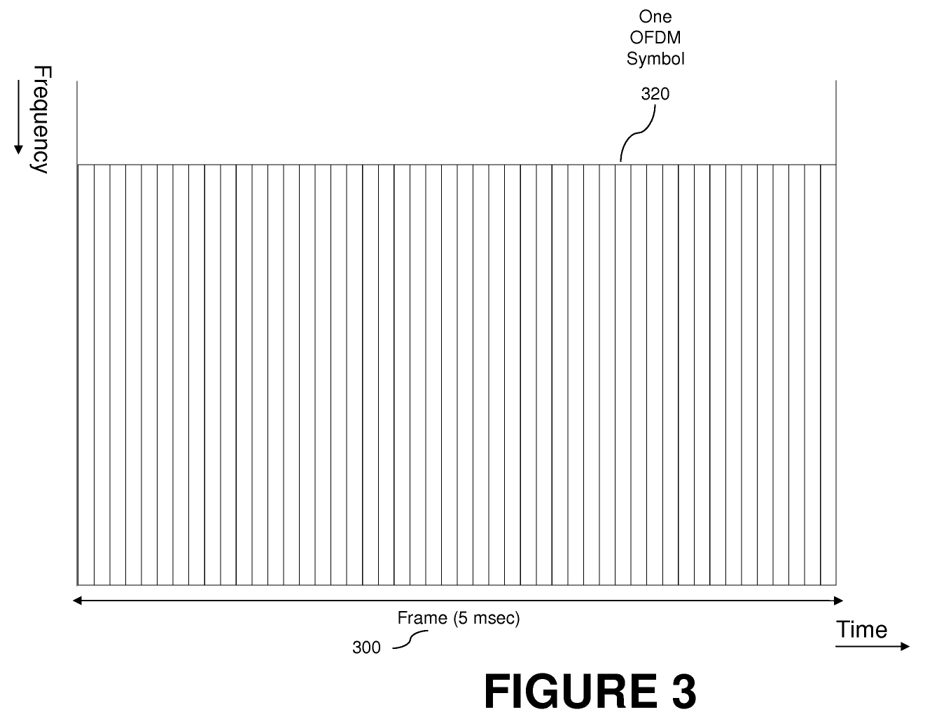

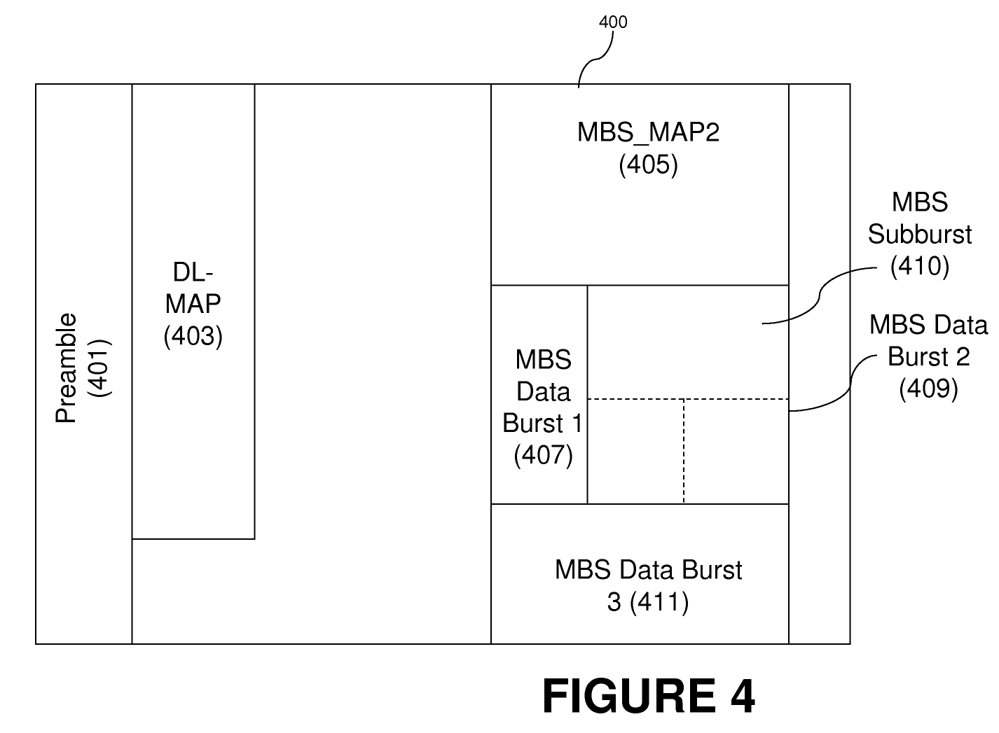

FIG. 3 illustrates a preferred embodiment of OFDMA time-frequency radio resources. In OFDMA systems, the time-frequency resources are preferably divided into OFDM symbols 320 and OFDM subcarriers for allocation to the MSs 120 by the BS 110 scheduler 140. In an example OFDMA system, the OFDM subcarriers are preferably approximately 10 kHz apart and the duration of each OFDM symbol is approximately 100 μs.

Preferably, the OFDM symbols 320 and OFDM subcarriers form one frame 300, such as a frame defined by the IEEE 802.16e standard. The frame 300 is preferably 5 ms in duration, although other durations may alternatively be used.

In this exemplary embodiment, the resources in the time domain (represented by the x-axis) are preferably divided into 48 OFDM symbols 320. In the frequency domain (represented by the y-axis), the resources are divided into multiple subchannels (not shown), wherein the size of each subchannel is dependent at least in part on a chosen subcarrier permutation scheme, which is a mapping from logical subchannels to physical subcarriers. Preferred subcarrier permutation schemes include Downlink (DL) partial usage of subcarriers (PUSC), DL full usage of subcarriers (FUSC), or uplink (UL) PUSC, all defined in the IEEE 802.16 standard. However, this list is meant to be merely illustrative, and any suitable subcarrier permutations may alternatively be used.

FIG. 4 illustrates a downlink frame 400 which preferably includes a preamble 401, DL-MAP 403, and an MBS_MAP2 405. Downlink frame 400 additionally comprises a plurality of MBS data bursts such as MBS Data Burst 1 407, MBS Data Burst 2 409, and MBS Data Burst 3 411, which preferably carry the actual data that is desired to be transmitted from the BS 110 to the MSs 120. Each MBS Data Burst (e.g., MBS Data Burst 2 409) may comprise multiple subbursts 410 (illustrated in FIG. 4 by the dashed lines) which may be associated with different MCIDs. The preamble 401 preferably transmits a synchronization signal for synchronizing acquisition between the BS 110 and the MS 120. As such, the preamble 401 is preferably located in the first OFDM symbol 320 at the beginning of the frame 300.

The DL-MAP 403 preferably contains information related to what data is transmitted in different zones of the DL and control information that may be needed to decode the data. This may be done by including within the DL-MAP 403 an MBS_MAP2_IE field (not shown) in order to provide information for locating and decoding the MBS_MAP2 405.

The MBS_MAP2 405 preferably contains information related to the physical channel resource allocation for specific subbursts 410 associated with specific MCIDs. For example, the MBS_MAP2 405 may provide any necessary modulation and coding information which may be used in the given physical channel resources of the MBS subbursts 410. The MBS_MAP2 405 is preferably located in the first data region of the DL permutation zone for MBS. The MBS_MAP2 405 may also contain information relating to the location of a subsequent MBS_MAP2 405.

Table 1 illustrates a preferred format for the MBS_MAP2 405.

TABLE 1

| | Size | |
|---|---|---|
| Syntax | (bit) | Notes |
| MBS_MAP2 Message format( ) { | — | — |
| Management Message Type = 70 | 8 | 70 (note: this can be any number assigned to |
| | | uniquely identify this management message, and is |
| | | not necessarily 70) |
| MBS_DIUC_Change_Count | 8 | — |
| #MBS_DATA2_IE | 4 | The number of included MBS DATA2 IEs |
| for(i = 0; i < n; i++){ | — | n = #MBS DATA2 IEs |
| MBS_DATA2_IE | variable | — |
| } | | |
| #MBS_DATA_Time_Diversity2_IE | 4 | The number of included MBS DATA Time |
| | | Diversity2 IEs |
| for(i = 0; i < k; i++) { | — | k = #MBS DATA Time Diversity2 IEs |
| MBS_DATA_Time_Diversity2_IE( ) | variable | — |
| } | | — |
| if(!byte boundary){ | | |
| Padding Nibble | 4 | — |
| } | — | — |
| TLV encoding element | — | — |
| } | — | — |

The MBS_MAP2 405 preferably comprises a Management Message Type field which indicates a type of management message, and may be any number used to uniquely identify the management message. The MBS_DIUC_Change Count field preferably indicates whether the MBS data burst profile is identical to a previously used MBS data burst profile. Additionally, the format of the MBS_MAP2 405 may include a padding nibble field, which allows the MBS_MAP2 405 to reach a desired length, and a TLV encoding element field.

Additionally, the MBS_MAP2 405 preferably comprises two additional information elements: MBS_DATA2_IE and MBS_DATA_Time_Diversity2_IE. Both of these two information elements preferably define the location and access information for particular subbursts 410 associated with particular MCIDs in the MBS data bursts, thereby allowing the MSs 120 to directly locate and decode only the subbursts 410 associated with their particular MCIDs without having to decode the entire MBS data burst and then discarding undesired portions.

Table 2 illustrates a preferred format for the first of these two information elements: MBS_DATA2_IE.

TABLE 2

| | Size | |
|---|---|---|
| Syntax | (bit) | Notes |
| MBS_DATA2_IE( ) { | — | — |
| MBS_MAP2 Type = 0 | 2 | MBS_DATA2_IE |
| No. of Multicast CID | 7 | — |
| for(i = 0; i < No. of Multicast CID; i++){ | — | — |
| Multicast CID | 8 | 8 LSBs of CID for multicast. |
| OFDMA Symbol Offset | 4 | OFDMA symbol offset of the burst containing the data |
| | | transmission for the Multicast CID; measured as an offset from |
| | | the OFDMA symbol either a) beginning the transmission of |
| | | this MAC Management message, if this is the first Multicast |
| | | CID in the list, or b) beginning the data transmission of the |
| | | immediate preceding Multicast CID |
| | | Another possible case is it may also possible to be measured as |
| | | a relative offset from the previous offset value |
| Subchannel Offset | 6 | OFDMA subchannel offset of the burst containing the data |
| | | transmission for the Multicast CID; measured as an offset from |
| | | the OFDMA subchannel either a) beginning the transmission of |
| | | this MAC Management message, if this is the first Multicast |
| | | CID in the list, or b) beginning the data transmission of the |
| | | immediate preceding Multicast CID |
| | | Another possible case is it may also possible to be measured as |
| | | a relative offset from the previous offset value |
| } | — | — |
| Boosting | 3 | |
| No. OFDMA Symbols | 7 | The size of MBS data. |
| No. Subchannels | 6 | — |
| Repetition Coding Indication | 2 | 0b00 - No repetition coding |
| | | 0b01 - Repetition coding of 2 used |
| | | 0b10 - Repetition coding of 4 used |
| | | 0b11 - Repetition coding of 6 used |
| Next MBS Frame Offset | 8 | A relative value from the current frame number in which the |
| | | next MBS MAP message will be transmitted. |
| Padding Nibble | variable | Padding to reach byte boundary |
| } | — | — |

In Table 2 the format of the MBS_DATA2_IE preferably includes an MBS_MAP Type field which is used to define which type of message (e.g., MBS_DATA2_IE or MBS_DATA_Time_Diversity2_IE) to be included within the MBS_MAP2 405. In one embodiment, the MBS_MAP Type field in both the MBS_DATA2_IE and the MBS_DATA_Time_Diversity2_IE is limited to 2 bits, thereby including only one of either the MBS_DATA2_IE or MBS_DATA_Time_Diversity2_IE messages. However, in other embodiments, the MBS_MAP Type may be expanded, e.g., to 3 bits, such that it can not only include the MBS_DATA2_IE but also the new MBS_DATA_Time_Diversity2_IE.

The MBS_DATA2_IE also preferably includes a Multicast CID field indicating multicast identifier information. Additionally, the MBS_DATA2_IE preferably includes a No. of OFDMA Symbols field and a No. Subchannels field to indicate the size of the MBS data bursts, a Repetition Coding Indication field with information required for decoding, and a Next MBS Frame Offset field with information to indicate the offset of an MBS-MAP in the next MBS frame.

To locate a specific subburst 410, the MBS_DATA2_IE also preferably includes an OFDMA Symbol Offset field and a Subchannel Offset field, which, when used together, can indicate the location of a particular subburst 410. The OFDA Symbol Offset field preferably comprises the OFDMA symbol offset of the MBS subburst 410 that contains the data transmission for the MCID. The OFDMA symbol offset may be measured either from the OFDMA symbol beginning the transmission of the MAC Management message if this is the first MCID in the list, or else the OFDMA symbol offset may be measured from the OFDMA symbol beginning the data transmission of the immediate preceding MCID. Alternatively, the OFDMA symbol offset may be measured as a relative offset from a previous offset value. Any of these measurements or other similar measurements may be utilized.

The Subchannel Offset field preferably comprises the OFDMA subchannel offset of the MBS subburst 410 containing the data transmission for the specific MCID. The OFDMA subchannel offset may be measured either from the OFDMA symbol beginning the transmission of the MAC Management message if this is the first MCID in the list, or else the OFDMA subchannel offset may be measured from the OFDMA symbol beginning the data transmission of the immediate preceding MCID. Alternatively, the OFDMA subchannel offset may be measured as a relative offset from a previous offset value. Any of these measurements or other similar measurements may be utilized.

Furthermore, the OFDMA symbol offset field and the Subchannel Offset field are preferably moved inside a for-loop for the MBS_DATA2_IE. Being located inside a for-loop allows the MSs 120 to only have to decode the MCIDs that are of interest without decoding the MCIDs that are not of interest. Without having to decode and discard MCIDs that are extraneous to the decoding MS 120, faster decoding and processing times can be realized.

A preferred format for the MBS_DATA_Time_Diversity2_IE, which is preferably used when the MSs 102 support a hybrid automatic repeat-request (HARQ) scheme, is illustrated in Table 3.

TABLE 3

| | Size | |
|---|---|---|
| Syntax | (bit) | Notes |
| MBS_DATA_Time_Diversity2_IE( ){ | — | — |
| MBS_MAP Type = 1 | 2 | — |
| No. of multicast CID | 7 | — |
| for(i = 0; i < n; i++) { | — | — |
| Multicast CID | 12 | 12 LBSs of CID for multicast |
| N_EP code | 4 | — |
| N_SCH code | 4 | — |
| AI_SN | 1 | — |
| SPID | 2 | — |
| ACID | 4 | — |
| OFDMA Symbol Offset | 7 | OFDMA symbol offset of the burst containing the |
| | | data transmission for the Multicast CID; measured |
| | | as an offset from the OFDMA symbol either a) |
| | | beginning the transmission of this MAC |
| | | Management message, if this is the first Multicast |
| | | CID in the list, or b) beginning the data transmission |
| | | of the immediate preceding Multicast CID |
| | | Another possible case is it may also possible to be |
| | | measured as a relative offset from the previous |
| | | offset value |
| Subchannel Offset | 6 | OFDMA subchannel offset of the burst containing |
| | | the data transmission for the Multicast CID; |
| | | measured as an offset from the OFDMA subchannel |
| | | either a) beginning the transmission of this MAC |
| | | Management message, if this is the first Multicast |
| | | CID in the list, or b) beginning the data transmission |
| | | of the immediate preceding Multicast CID |
| | | Another possible case is it may also possible to be |
| | | measured as a relative offset from the previous |
| | | offset value |
| } | | |
| No. OFDMA Symbols | 7 | The size of MBS data. |
| No. Subchannels | 6 | — |
| Repetition Coding Indication | 2 | 0b00 - No repetition coding |
| | | 0b01 - Repetition coding of 2 used |
| | | 0b10 - Repetition coding of 4 used |
| | | 0b11 - Repetition coding of 6 used |
| Next MBS Frame Offset | 8 | A relative value from the current frame number in |
| | | which the next MBS MAP message that contains |
| | | these MCIDs will be transmitted. |
| } | — | — |

As shown, the MBS_DATA_Time_Diversity2_IE preferably has multiple information elements. For example, the MBS_DATA_Time_Diversity2_IE preferably has a MBS_MAP_Type field which indicates that the information elements in Table 3 are MBS_DATA_Time_Diversity2_IE. Further, the Multicast CID field indicates information on a multicast identifier.

The N_EP code field, N_SCH code field, ARQ Identifier_Sequence Number (AI_SN) field, Sub_Packet IDentifier (SPID) field, and Hybrid ARQ Channel IDentifier (ACID) field preferably indicate information used for decoding the HARQ data. The Next MBS frame offset field preferably indicates an offset of the next MBS frame.

Furthermore, similar to the MBS_DATA2_IE, the MBS_DATA_Time_Diversity2_IE also preferably includes an OFDMA Symbol Offset field and a Subchannel Offset field which may be used to locate specific subbursts 410 associated with particular MCIDs. The OFDMA Symbol Offset field preferably comprises the OFDMA symbol offset of the MBS subburst 410 that contains the data transmission for the MCID. The OFDMA symbol offset may be measured either from the OFDMA symbol beginning the transmission of the MAC Management message if this is the first MCID in the list, or else the OFDMA symbol offset may be measured from the OFDMA symbol beginning the data transmission of the immediate preceding MCID. Alternatively, the OFDMA symbol offset may be measured as a relative offset from a previous offset value. Any of these measurements or other similar measurements may be utilized.

The Subchannel Offset field preferably comprises the OFDMA subchannel offset of the MBS subburst 410 containing the data transmission for the MCID. The OFDMA subchannel offset may be measured either from the OFDMA symbol beginning the transmission of the MAC Management message if this is the first MCID in the list, or else the OFDMA subchannel offset may be measured from the OFDMA symbol beginning the data transmission of the immediate preceding MCID. Alternatively, the OFDMA subchannel offset may be measured as a relative offset from a previous offset value. Any of these measurements or other similar measurements may be utilized.

Furthermore, the OFDMA Symbol Offset and the Subchannel Offset parameters are preferably moved inside a for-loop for the MBS_DATA_Time_Diversity2_IE. Being located inside a for-loop allows the MSs 120 to only have to decode the subbursts 410 that are of interest without decoding the remainder of the subbursts 410 that are not of interest. Without having to decode and discard subbursts 410 that are extraneous to the decoding MS 120, faster decoding and processing times can be realized.

However, as one of ordinary skill in the art will recognize, there are multiple methods of including the MBS_DATA2_IE and the MBS_DATA_Time_Diversity2_IE with the MBS_MAP2 405. For example, a prior art MBS_MAP message, such as the ones defined in 802.16 with the type 62, may be modified to include only the MBS_DATA2_IE described above. This can be done by setting the MBS_MAP_TYPE to a new Type 3. Alternatively, the prior art MBS_MAP message may be modified to include only the MBS_DATA_Time_Diversity2_IE, which would preferably use a new MBS_MAP Type 4.

Also, by the inclusion of the MBS_DATA2_IE and the MBS_DATA_Time_Diversity2_IE with the MBS_MAP2 405 as described above, certain other parameters may be excluded from the MBS_DATA2_IE and the MBS_DATA_Time_Diversity2_IE. These potentially excluded parameters include “MBS Burst Frame Offset,” “Next MBS MAP change indication,” “MBS DIUC,” “Next MBS Number,” “OFDMA Symbols,” and/or “Next MBS Number.” By excluding these parameters, the size of the MBS_DATA2_IE and the MBS_DATA_Time_Diversity2_IE may potentially be reduced.

Although the present invention and its advantages have been described in detail, it should be understood that various changes, substitutions and alterations can be made herein without departing from the spirit and scope of the invention as defined by the appended claims. For example, either MBS_DATA2_IE, MBS_DATA_Time_Diversity2_IE, or any combination of these may alternatively be included within the MBS_MAP2. Additionally, OFDMA subchannels from an existing MBS_DATA2_IE and MBS_DATA_Time_Diversity2_IE may optionally be removed.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for receiving data, the method comprising:
receiving a plurality of data subbursts at a mobile station with a first identifier, the data subbursts being associated with different identifiers, one or more of the different identifiers being the first identifier;
receiving an indicator message at the mobile station, the indicator message indicating a location of a first one of the plurality of data subbursts with the first identifier; and
decoding the first one of the plurality of data subbursts with the first identifier without decoding a second one of the plurality of data subbursts.

2. The method of claim 1, wherein receiving an indicator message further comprises receiving information related to physical channel resource allocations and coding for the plurality of data subbursts.

3. The method of claim 2, wherein receiving an indicator message further comprises receiving an indication of a symbol offset.

4. The method of claim 3, wherein the symbol offset is measured as a relative offset from a previously received symbol offset.

5. The method of claim 2, wherein receiving an indicator message further comprises receiving an indication of a subchannel offset.

6. The method of claim 5, wherein the subchannel offset is measured as a relative offset from a previously received subchannel offset.

7. The method of claim 1, wherein receiving an indicator message further comprises receiving a MBS_MAP2.

8. The method of claim 7, wherein receiving a MBS_MAP2 further comprises receiving a MBS_DATA2_IE.

9. The method of claim 8, wherein the location is indicated by an OFDMA symbol offset field in the MBS_DATA2_IE, the OFDMA symbol offset field comprising an offset measured as a relative offset from a previous offset value.

10. The method of claim 8, wherein the location is indicated by an OFDMA symbol offset field in the MBS_DATA2_IE, the OFDMA symbol offset field comprising an offset measured from an OFDMA symbol first received.

11. The method of claim 8, wherein the location is indicated by an OFDMA symbol offset field in the MBS_DATA2_IE, the OFDMA symbol offset field comprising an offset measured from a beginning OFDMA symbol of an immediately preceding one of the plurality of data subbursts.

12. The method of claim 8, wherein the location is indicated by a subchannel offset field in the MBS_DATA2_IE, the subchannel offset field comprising an offset measured as a relative offset from a previous offset value.

13. The method of claim 8, wherein the location is indicated by a subchannel symbol offset field in the MBS_DATA2_IE, the subchannel symbol offset field comprising an offset measured from an OFDMA symbol first received.

14. The method of claim 8, wherein the location is indicated by a subchannel symbol offset field in the MBS_DATA2_IE, the subchannel symbol offset field comprising an offset measured from a beginning OFDMA symbol of an immediately preceding one of the plurality of data subbursts.

15. A method for transmitting data, the method comprising:
transmitting a first data subburst with a first identifier;
transmitting a second data subburst with a second identifier different from the first identifier; and
transmitting an indication of a location of the first data subburst and the second data subburst, the indication of the location being associated with the first identifier and the second identifier.

16. The method of claim 15, wherein transmitting the indication further comprises transmitting a MBS_MAP2 comprising the location of the first data subburst and the second data subburst.

17. The method of claim 16, wherein transmitting a MBS_MAP2 further comprises transmitting a MBS_DATA2_IE comprising the location of the first data subburst and the second data subburst.

18. The method of claim 17, wherein the MBS_DATA2_IE further comprises an OFDMA symbol offset field, the OFDMA symbol offset field comprising an offset measured as a relative offset from a previous offset value.

19. The method of claim 17, wherein the MBS_DATA2_IE further comprises an OFDMA symbol offset field, the OFDMA symbol offset field comprising an offset measured from an OFDMA symbol first received.

20. The method of claim 17, wherein the MBS_DATA2_IE further comprises an OFDMA symbol offset field, the OFDMA symbol offset field comprising an offset measured from a beginning OFDMA symbol of a third data subburst immediately preceding the first data subburst.

21. The method of claim 16, wherein transmitting a MBS_MAP2 further comprises transmitting a MBS_DATA_Time_Diversity2_IE comprising the location of the first data subburst and the second data subburst.

22. The method of claim 21, wherein the MBS_DATA_Time_Diversity2_IE further comprises an OFDMA symbol offset field, the OFDMA symbol offset field comprising an offset measured as a relative offset from the previous offset value.

23. The method of claim 21, wherein the MBS_DATA_Time_Diversity2_IE further comprises an OFDMA symbol offset field, the OFDMA symbol offset field comprising an offset measured from an OFDMA symbol first received.

24. The method of claim 21, wherein the MBS_DATA_Time_Diversity2_IE further comprises an OFDMA symbol offset field, the OFDMA symbol offset field comprising an offset measured from a beginning OFDMA symbol of a third data subburst immediately preceding the first data subburst.

25. A method for receiving data, the method comprising:
receiving an MBS_MAP2 at a wireless mobile station, the MBS_MAP2 comprising an MBS_DATA2_IE;
receiving a first data subburst with a first channel identification and a second data subburst with a second channel identification different from the first channel identification;
processing the MBS_DATA2_IE to obtain a location of the first data subburst; and
decoding the first data subburst without decoding the second data subburst.

26. The method of claim 25, wherein the MBS_DATA2_IE further comprises an OFDMA symbol offset field, the OFDMA symbol offset field comprising an offset measured as a relative offset from the previous offset value.

27. The method of claim 25, wherein the MBS_DATA2_IE further comprises an OFDMA symbol offset field, the OFDMA symbol offset field comprising an offset measured from an OFDMA symbol first received.

28. The method of claim 25, wherein the MBS_DATA2_IE further comprises an OFDMA symbol offset field, the OFDMA symbol offset field comprising an offset measured from a beginning OFDMA symbol of a third data subburst immediately preceding the first data subburst.
